(19) United States
(12) Patent Application Publication
(10) Pub. No.: US 2011/0191720 A1
(43) Pub. Date: Aug. 4, 2011

(54) METHOD AND APPARATUS FOR DISPLAYING MENUS

(75) Inventor: Kyung-il LEE, Suwon-si (KR)

(73) Assignee: SAMSUNG ELECTRONICS CO., LTD., Suwon-si (KR)

(21) Appl. No.: 12/911,459

(22) Filed: Oct. 25, 2010

(30) Foreign Application Priority Data
Feb. 4, 2010 (KR) 10-2010-0010476

(51) Int. Cl. G06F 3/048

(52) U.S. Cl. 715/838

(57) ABSTRACT

A method for displaying a menu includes generating a content selection menu which includes a plurality of contents and a location selection menu which includes a plurality of locations within a content that is currently selected among the plurality of contents, by using information about at least one of the contents, and displaying the content selection menu and the location selection menu on a single screen.

### CROSS-REFERENCE TO RELATED PATENT APPLICATION

This application claims the benefit of Korean Patent Application No. 10-2010-0010476, filed on Feb. 4, 2010, in the Korean Intellectual Property Office, the disclosure of which is incorporated herein in its entirety by reference.

### BACKGROUND

1. Field

Exemplary embodiments relate to multimedia content use, and more particularly, to a method and apparatus for displaying a menu for selecting and reproducing multimedia content.

2. Description of the Related Art

Recently, users have increasingly used portable devices to view multimedia content, and as a result, high-performance portable devices and high-capacity storage media have been developed. Users may view certain multimedia content through portable devices, as follows. When desired content is selected from a content selection menu including a content list or a content image list from which a name or reproduction period of time of the content may be obtained, the content is reproduced from the beginning. In order to view the content from a desired location instead of from the beginning, the image needs to be first moved to a thumbnail selection menu of the content. The thumbnail selection menu refers to a menu for showing a thumbnail image corresponding to a plurality of time periods obtained by dividing the content into predetermined time intervals, and for selecting a desired location by a user. When the user selects a thumbnail image from the thumbnail selection menu, the content is reproduced from a location corresponding to the respective time period.

When a user wants to view another piece of content, the user returns to the content selection menu, which is an upper menu of the thumbnail selection menu, selects desired content, and calls the thumbnail selection menu again. Then, when the thumbnail selection menu is displayed on a screen, the user selects a desired location, and thus the content is reproduced.

In the case of image files or music files stored in portable devices, while a user views content included in the current folder, if the user wants to view content contained in another folder, the user needs to move to an upper folder menu, select another folder, and then select the content.

### SUMMARY

Exemplary embodiments provide a method and apparatus for displaying a menu in which a user may conveniently view and select multimedia content by manipulating different levels of menus on a single image.

According to an aspect of an exemplary embodiment, there is provided a method of displaying a menu, the method including generating a content selection menu which includes a plurality of contents and a location selection menu which includes a plurality of locations corresponding to one of the plurality of contents, by using information about at least one of the plurality of contents; and displaying the content selection menu and the location selection menu on a single image.

The method may further include, when a command for reproduction is input, reproducing the selected one of the plurality of contents from a location selected through the location selection menu among the plurality of locations.

The content selection menu and the location selection menu may be displayed to cross each other.

The location selection menu may include a plurality of thumbnail images corresponding to at least one scene included in the selected one of the plurality of contents.

The content selection menu may include a plurality of thumbnail images corresponding to the plurality of contents.

The content selection menu may include a plurality of thumbnail images arranged in a vertical direction, corresponding to the plurality of contents, wherein the location selection menu may include a plurality of thumbnail images arranged in a horizontal direction, corresponding to at least one scene in the selected one of the plurality of contents, and wherein the content selection menu may cross the location selection menu at a portion corresponding to the content that is currently selected.

The method may further include displaying information regarding a location in the content corresponding to a scene that is currently selected.

According to an aspect of another exemplary embodiment, there is provided a computer readable recording medium having recorded thereon a program for executing a method of displaying a menu, the method including generating a content selection menu which includes a plurality of contents and a location selection menu which includes a plurality of locations corresponding to one of the plurality of contents, by using information about at least one of the plurality of contents; and displaying the content selection menu and the location selection menu on a single image.

According to an aspect of another exemplary embodiment, a method of displaying information includes generating a first menu which includes a plurality of folders, each folder comprising a plurality of contents; generating a second menu which includes the plurality of contents of one of the plurality of folders; and displaying the first menu and the second menu simultaneously on a single screen.

The first menu may extend along one path and the second menu may extend along a second path which intersects the first path.

The first menu and the second menu may intersect one another at a selected one of the plurality of folders and at a selected one of the plurality of contents.

### BRIEF DESCRIPTION OF THE DRAWINGS

The above and other features will become more apparent by describing in detail exemplary embodiments thereof with reference to the attached drawings in which:

FIG. 1 is a block diagram of a menu displaying apparatus according to an exemplary embodiment;

FIG. 2 is a flow chart of a method of displaying a menu, according to an exemplary embodiment;

FIG. 3 is a diagram of an image on which menus are displayed, according to an exemplary embodiment;

FIG. 4 is a diagram for explaining a case where moving image content is applied to an image on which menus are displayed, according to an exemplary embodiment; and

FIG. 5 is a diagram for explaining a case where music content is applied to an image on which menus are displayed, according to an exemplary embodiment.

### DETAILED DESCRIPTION OF THE INVENTION EXEMPLARY EMBODIMENTS

Hereinafter, the exemplary embodiments will be described in detail with reference to the attached drawings.

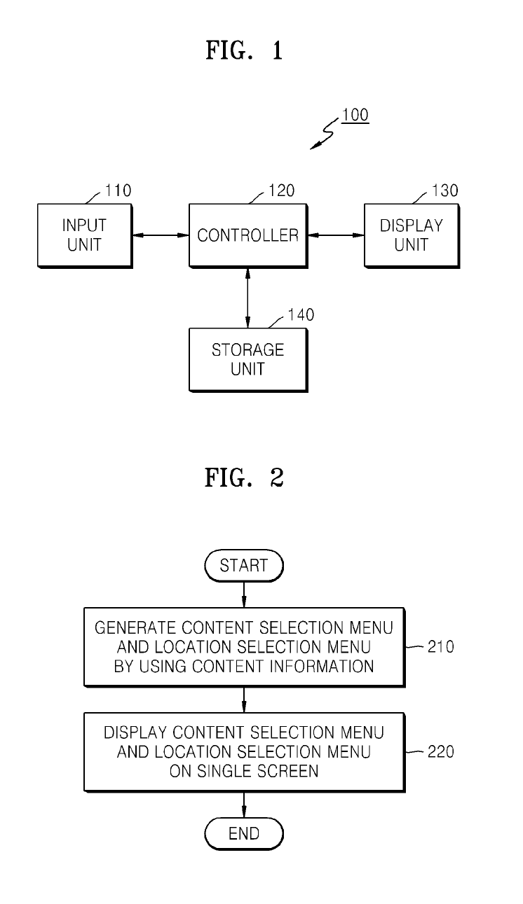

FIG. 1 is a block diagram of a menu displaying apparatus 100 according to an exemplary.

Referring to FIG. 1, the menu displaying apparatus 100 includes an input unit 110 for receiving a user's command, a display unit 130 for showing a menu image and a content reproduction result to a user, a storage unit 140 for storing information about at least one piece of content (hereinafter, referred to as content information), and a controller 120 for controlling the display unit 130 to generate a selection menu of an upper level and a selection menu of a lower level by using the content information stored in the storage unit 140 and to simultaneously display the generated selection menus. The phrase “a menu of an upper level” and the like, as used herein refers to a menu or folder which includes a menu or folder of the lower level.

Examples of the selection menu of the upper level and the selection menu of the lower level may include a content selection menu and a location selection menu for selecting a location in content that is currently selected. In this case, the content information is information for constructing a content selection menu for selecting described content from among a plurality of pieces of content, and a location selection menu for selecting a desired location from among a plurality of locations in each piece of content. The location in the content is a location which a user wants to manipulate, such as performing reproduction or editing. When the location in the content is a reproduction start location, the content information stored in the storage unit 140 may include a name of each content file, an entire reproduction period of time of each piece of content, and information about a plurality of reproduction start locations included in each piece of content. The reproduction start locations are defined as start points of respective segments formed by dividing content into a plurality of segments. For example, the reproduction start locations may be defined as start points of respective periods of time formed by dividing the content into the periods of time, or may be defined as a start location of each scene included in the content. However, the exemplary embodiment is not limited thereto. In addition, the reproduction start locations may be embodied in various other ways.

The controller 120 displays the content selection menu and the location selection menu on a single screen. The content selection menu includes an available content list, and the location selection menu includes a plurality of locations in the content that is currently selected. The controller 120 performs a command according to the user's key manipulation input to the input unit 110. When a key corresponding to a content-change is pushed, the controller 120 changes the content to select another piece of content, and generates and displays the location selection menu corresponding to the changed content. When a key corresponding to a location-change is pushed, the controller 120 changes the location of the location selection menu to another menu item, and displays the result. When a key corresponding to a reproduction-command is pushed, the controller 120 reproduces the content that is currently selected, from a location that is currently selected.

FIG. 2 is a flow chart of a method of displaying a menu, according to an exemplary embodiment.

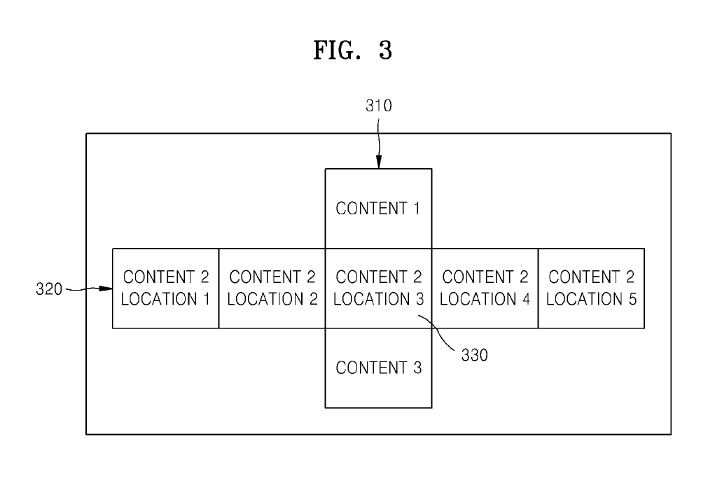

Referring to FIG. 2, a first menu, for example, a content selection menu 310, and a second menu, for example, a location selection menu 320, are generated using content information (operation 210), and the generated menus are display on a single screen (operation 220). FIG. 3 is a diagram of a screen on which menus are displayed, according to an exemplary embodiment. Referring to FIG. 3, a content selection menu 310 including a content list, and a location selection menu 320 including a plurality of reproduction start locations are displayed to cross each other at a portion 330 corresponding to content that is currently selected and a location that is currently selected. In FIG. 3, the content selection menu 310 is disposed in a vertical direction, and the location selection menu 320 is disposed in a horizontal direction, but may be arranged with the content selection menu 310 disposed in a horizontal direction and the location selection menu 320 disposed in a vertical direction. While a user simultaneously views the content selection menu 310 and the location selection menu 320, the user may select a desired content, and may select a desired location in the selected content through the input unit 110.

Referring to FIG. 3, content 2 is selected, locations 1 through 5 are displayed as a plurality of reproduction start locations included in the content 2, and the location 3 is selected at portion 330 from among the locations. When the user selects the content 1, a location selection menu regarding the content 1 may be generated and displayed instead of the location selection menu 320 regarding the content 2. The user selects the content 2 as desired content through the user's key manipulation input to the input unit 110, selects the location 3 at portion 330 as a desired reproduction start location through the user's key manipulation, and then the content 2 is reproduced from the location 3 by inputting a reproduction command through a predetermined key input.

Referring to FIG. 3, only three pieces of content from among available contents are displayed on the image, and only five reproduction start locations are displayed on the screen. Only a predetermined number of menu items are displayed to correspond to a small displaying monitor of a portable device. In addition, whenever key manipulation is performed, menu arrangement may be changed so that the current content and the current reproduction start location may be located in the center of the screen. For example, when the content 3 is selected, the location selection menu regarding the content 3 is displayed in the center of the image in a horizontal direction, a menu item corresponding to the content 2 is moved upwards, and a menu item corresponding to the content 4 is moved downwards.

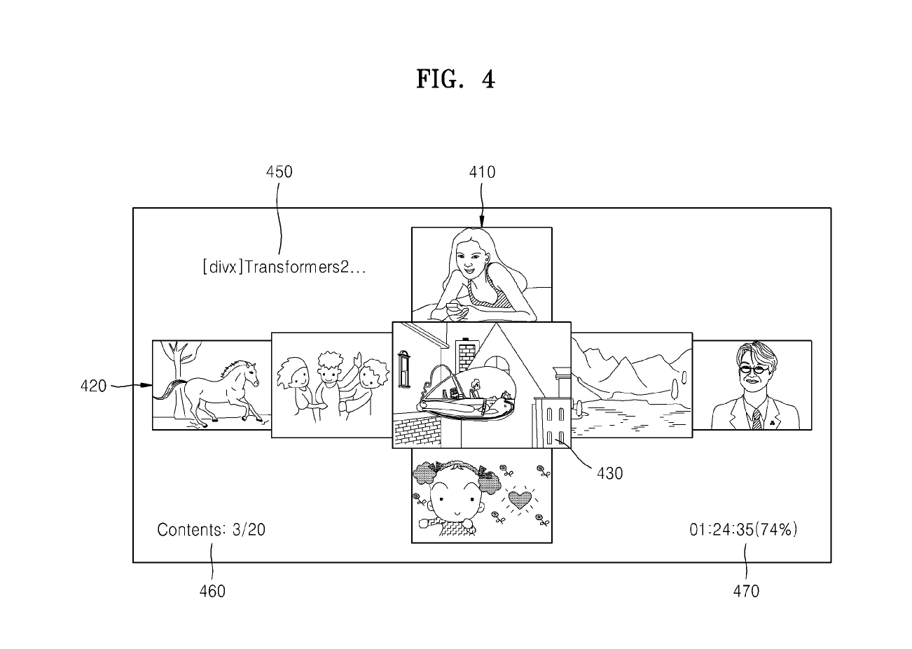

FIG. 4 is a diagram for explaining a case where moving image content is applied to an screen on which menus are displayed, according to an exemplary embodiment.

Referring to FIG. 4, a content selection menu 410 includes a list of thumbnails indicating moving image contents, and a location selection menu 420 includes a list of thumbnail images corresponding to respective sets of at least one image included in moving image content that is currently selected. When a thumbnail image 430 corresponds to a reproduction start location that is currently selected, and corresponds to the moving image content that is currently selected, the thumbnail image 430 is displayed larger than the other thumbnail images to be distinguished therefrom. A reproduction start location of the moving image content may be changed by a right and left scroll element, and the moving image content may be changed to another piece of moving image content by using an up and down scroll element. Information regarding content that is currently selected is displayed outside a region where the menus are displayed to cross each other. For example, a name 450 of the moving image content that is currently selected, numbers 460 of available moving image contents and the number of the moving image content that is currently selected, and a location 470 within the moving image content of a scene that is currently selected, may be displayed. The location 470 in the moving image content of the scene that is currently selected may be displayed as time information and/or a percentage, for example.

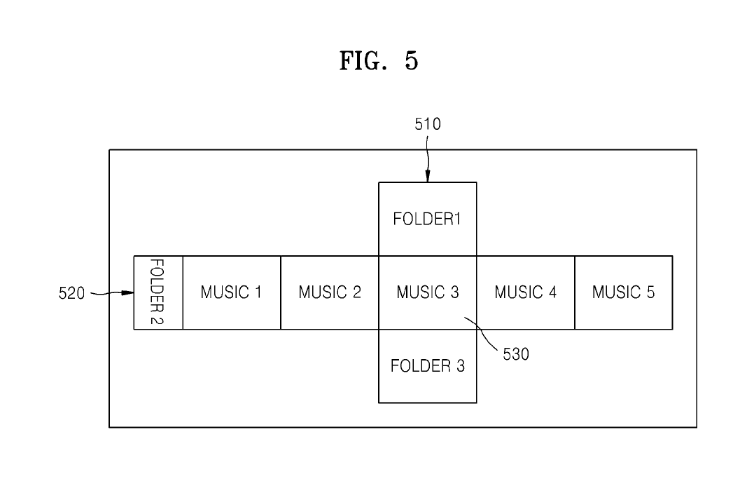

FIG. 5 is a diagram for explaining a case where music content is applied to a screen on which menus are displayed, according to an exemplary embodiment.

Referring to FIG. 5, a folder list 510 is disposed in a vertical direction, and a music content list 520 contained in a current folder is disposed in a horizontal direction. Information regarding music content that is currently selected may be displayed in an empty portion. The music content included in the current folder may be viewed or selected by manipulating a right and left key, and the user may easily move to another folder by manipulating an up and down key. In FIG. 5, music 3 of a folder 2 is currently selected at portion 530, and the music 3 is reproduced by inputting a reproduction command. When another folder is selected, a corresponding music content list is displayed. Alternatively, the present exemplary embodiment may be applied to another kind of content, apart from the music content.

According to the exemplary embodiments, a user may conveniently and efficiently select desired content without switching screens, and thus may first view a desired portion, and an image, on which menus for attracting the user's interest are displayed.

The exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the inventive concept has been particularly shown and described with reference to exemplary embodiments thereof, it will be understood by those of ordinary skill in the art that various changes in form and details may be made therein without departing from the spirit and scope of the inventive concept.

What is claimed is:

1. A method of displaying a menu, the method comprising:
generating a content selection menu which comprises a plurality of contents and a location selection menu which comprises a plurality of locations corresponding to one of the plurality of contents that is selected, by using information about the plurality of contents; and
displaying the content selection menu and the location selection menu on a single screen.

2. The method of claim 1, further comprising, when a command for reproduction is input, reproducing the selected one of the plurality of contents from a location selected through the location selection menu among the plurality of locations.

3. The method of claim 1, wherein the content selection menu and the location selection menu are displayed to cross each other.

4. The method of claim 1, wherein the location selection menu comprises a plurality of thumbnail images corresponding to a plurality of scenes in the selected one of the plurality of contents.

5. The method of claim 1, wherein the content selection menu comprises a plurality of thumbnail images corresponding to the plurality of contents.

6. The method of claim 1, wherein the content selection menu comprises a plurality of thumbnail images arranged in a vertical direction, corresponding to the plurality of contents,
wherein the location selection menu comprises a plurality of thumbnail images arranged in a horizontal direction, corresponding to a plurality of scenes in the selected one of the plurality of contents, and
wherein the content selection menu crosses the location selection menu at an area corresponding to the selected one of the plurality of contents.

7. The method of claim 6, further comprising displaying information regarding a location in the content corresponding to a scene that is selected.

8. A computer readable recording medium having recorded thereon a program for executing a method of displaying a menu, the method comprising:
generating a content selection menu which comprises a plurality of contents and a location selection menu which comprises a plurality of locations corresponding to one of the plurality of contents, by using information about the plurality of the contents; and
displaying the content selection menu and the location selection menu on a single screen.

9. A menu displaying apparatus comprising:
a display unit;
a storage unit which stores information about a plurality of contents; and
a controller which generates a content selection menu which comprises the plurality of contents and a location selection menu which comprises a plurality of locations corresponding to one of the plurality of contents that is selected, by using the information about the plurality of contents, and which controls the display unit to simultaneously display the content selection menu and the location selection menu.

10. The menu displaying apparatus of claim 9, wherein, when a command for reproduction is input, the controller reproduces the content that is selected among the plurality of contents from a location selected through the location selection menu among the plurality of locations.

11. The menu displaying apparatus of claim 9, wherein the controller displays the content selection menu and the location selection menu so as to cross each other.

12. The menu displaying apparatus of claim 9, wherein the controller generates the location selection menu comprising a plurality of thumbnail images corresponding to a plurality of scenes in the selected one of the plurality of contents.

13. The menu displaying apparatus of claim 9, wherein the controller generates the content selection menu comprising a plurality of thumbnail images corresponding to the plurality of contents.

14. The menu displaying apparatus of claim 9, wherein the controller generates the content selection menu comprising a plurality of thumbnail images arranged in a vertical direction, corresponding to the plurality of contents, and the location selection menu comprising a plurality of thumbnail images arranged in a horizontal direction, corresponding to a plurality of scenes in the selected one of the plurality of contents, and
wherein the controller controls the display unit to display the content selection menu and the location selection menu so as to cross each other at an area corresponding to the selected one of the plurality of contents

15. The menu displaying apparatus of claim 14, wherein the controller controls the display unit to display information regarding a location in content corresponding to a scene that is currently selected.

16. A method of displaying information, the method comprising:
generating a first menu which comprises a plurality of folders, one of the plurality of folders comprising a plurality of contents;
generating a second menu which comprises the plurality of contents of one of the plurality of folders; and
displaying the first menu and the second menu simultaneously on a single screen.

17. The method of claim 16, wherein the first menu extends along one path and the second menu extends along a second path which intersects the first path.

18. The method of claim 17, wherein the first menu and the second menu intersect at a selected one of the plurality of folders and at a selected one of the plurality of contents.
